(19) United States
(12) Patent Application Publication
(10) Pub. No.: US 2013/0160039 A1
(43) Pub. Date: Jun. 20, 2013

(54) METHOD AND APPARATUS FOR DETERMINING INDIVIDUALIZED MEDIA METRICS, AND PROVIDING INDIVIDUALIZED CONDITIONAL ACCESS FOR 3D IMAGE VIEWING

(71) Applicants: James Mentz, Gainesville, FL (US); Samuel Caldlwell, Palm Harbor, FL (US)

(72) Inventors: James Mentz, Gainesville, FL (US); Samuel Caldlwell, Palm Harbor, FL (US)

(73) Assignee: BIT CAULDRON CORPORATION, Gainesville, FL (US)

(21) Appl. No.: 13/528,728

(22) Filed: Jun. 20, 2012

Related U.S. Application Data
(60) Provisional application No. 61/498,829, filed on Jun. 20, 2011.

(51) Int. Cl. H04N 21/418; H04N 21/442

(52) U.S. Cl. CPC H04N 21/418; H04N 21/44222
USPC 725/14; 725/25; 725/31

(57) ABSTRACT

Embodiments of the present invention relate to a system and method for providing video content to one or more viewers. Specific embodiments are related to providing video content to two or more viewers, three or more viewers, four or more viewers, five or more viewers, ten or more viewers, and more than ten viewers. Specific embodiments can utilize 3D shutter glasses and/or a communication path in a 3D image viewing system utilizing shutter glasses to allow the purchase, or use of, subscription, pay-per-view, or on-demand content. The purchase, or use of, such content can be limited for use by a specific number of viewers. The number of viewers can be selected by the operator of a remote control or other human interface device at the time of purchase, or before or after the time or purchase. The number of viewers can be incrementally increased, or decreased, after the initial time of purchase, such as via the remote control or other human interface device.

### CROSS-REFERENCE TO RELATED APPLICATION

The present application claims the benefit of U.S. Provisional Application Ser. No. 61/498,829, filed Jun. 20, 2011, which is hereby incorporated by reference herein in its entirety, including any figures, tables, or drawings.

### BACKGROUND OF INVENTION

The present invention relates to stereoscopic 3D image viewing methods and apparatus. More particularly, the present invention relates to stereoscopic 3D image viewing devices and systems incorporating individualized media metrics and individualized conditional access.

When two-dimensional images that represent left and right points of view are sensed by respective left and right eyes of a user, the user typically experiences the perception of a 3D image from the two-dimensional images. There are several systems that allow users (e.g., individuals or groups) to perceive stereoscopic 3D depth in images, photos, pictures, moving pictures, videos, or the like, by the selective transmission of images to a users' eyes. Such systems include the use of display systems, including light projection/reflection within a public or home theater or emissive or transmissive displays (e.g., LCD, plasma display, flat-panel display, or the like) to alternatively or simultaneously output right eye images and left eye images to a user. To view such 3D images, a variety of approaches have been provided to the user including prisms, static polarized glasses, LCD shutter glasses, or the like.

One approach to 3D visualization has included the use of stereoscopic shutter glasses that are based upon physical shutters, or more commonly liquid crystal display (LCD) technology. With such approaches, left and right images are alternatively displayed to the user, and the right and left LCD lenses alternate between a dark and transparent state. When the shutter glasses quickly alternate between transparency in the left then right eyes in synchronization with an image which presents alternating left and right points of view, the left and right eyes receive different 2D images and the observer experiences the perception of depth in a 3D image.

A typical stereoscopic system typically includes a computer, an infrared or RF transmitter, a display, and a pair of liquid crystal display glasses (LCD shutter glasses). In such systems, computer alternatively provides left eye images and right eye images on signal line, in addition to a signal that distinguishes when the left eye image or right eye image is displayed.

In response to the signal, an IR or RF transmitter outputs infrared or RF data that indicate when the right eye image is being output and when the left eye image is being output.

In various systems, infrared or RF data is received by LCD shutter glasses, and in response, for example, the right LCD of the LCD glasses becomes opaque and the left LCD becomes translucent (i.e., clear), or the left LCD of the LCD glasses becomes opaque and the right LCD becomes translucent. Ideally, at the same time the right LCD becomes translucent, display is displaying a right eye image, and when the left LCD becomes translucent, display is displaying a left eye image.

It would be advantageous to have a method and apparatus for conditionally providing to a viewer with shutter glasses access to a portion, or all, of the content being presented on a display, which requires operating shutter glasses to view. It would also be advantageous to have a method and apparatus for determining individualized media metrics from 3D image viewers.

### BRIEF DESCRIPTION OF DRAWINGS

FIG. 1 shows a block diagram illustrating aspects of the prior art.

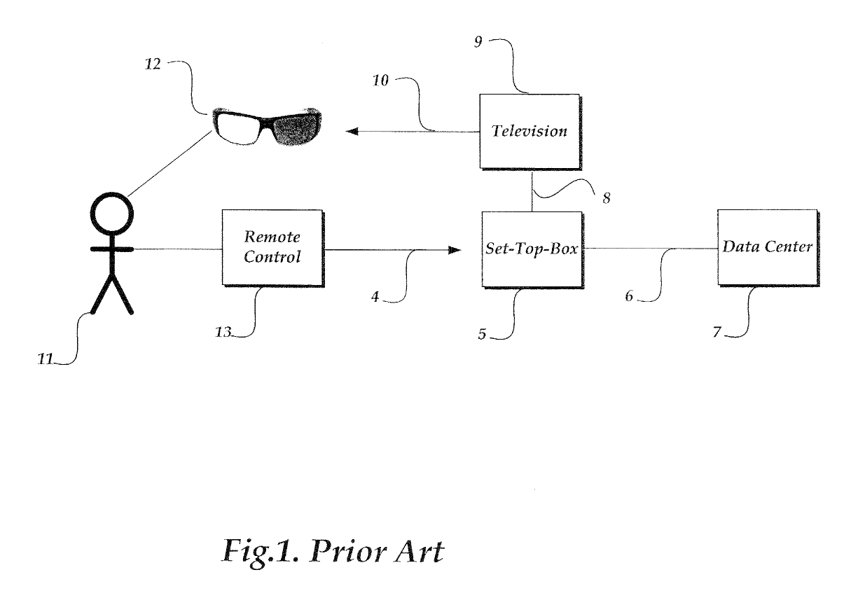

FIG. 2 is a block diagram illustrating a per-person conditional access system where the display is authorized for conditional access.

FIG. 3 is a block diagram illustrating a per-person conditional access system where the television authorizes the glasses for conditional access.

FIG. 4 is a block diagram illustrating a per-person conditional access system where the set-top-box authorizes the television and authorizes the glasses via the television.

FIG. 5 is a block diagram illustrating a per-person conditional access system where the set-top-box authorizes the television and authorizes the glasses via the television.

FIG. 6 is a block diagram illustrating a per-person conditional access system where the set-top-box authorizes the television and authorizes the glasses via the television.

FIG. 7 is a block diagram illustrating individualized media metrics collected by a television.

FIG. 8 is a block diagram illustrating individualized media metrics collected by a television.

FIG. 9 is an example graph of the individualized media metrics collected in accordance with an embodiment of the invention.

### DETAILED DISCLOSURE

Embodiments of the present invention relate to a system and method for providing video content to one or more viewers. Specific embodiments are related to providing video content to two or more viewers, three or more viewers, four or more viewers, five or more viewers, ten or more viewers, and more than ten viewers. Specific embodiments can utilize 3D shutter glasses and/or a communication path in a 3D image viewing system utilizing shutter glasses to allow the purchase, or use of, subscription, pay-per-view, or on-demand content. The purchase, or use of, such content can be limited for use by a specific number of viewers. The number of viewers can be selected by the operator of a remote control or other human interface device at the time of purchase, or before or after the time or purchase. The number of viewers can be incrementally increased, or decreased, after the initial time of purchase, such as via the remote control or other human interface device.

In a specific embodiment, the number of viewers is automatically incrementally increased, and/or decreased, after the initial time of purchase, or after the initial number of viewers is originally selected, as additional viewers attempt to use the content, and/or discontinue use. The cost of the content can be determined by the number of viewers, by tiers of maximum numbers of viewers, or by a formula based on a variety of factors such as number of viewers and how long each viewer viewed the content. In an embodiment, the cost of the content is adjusted automatically as additional viewers use the content, and/or as viewers discontinue use.

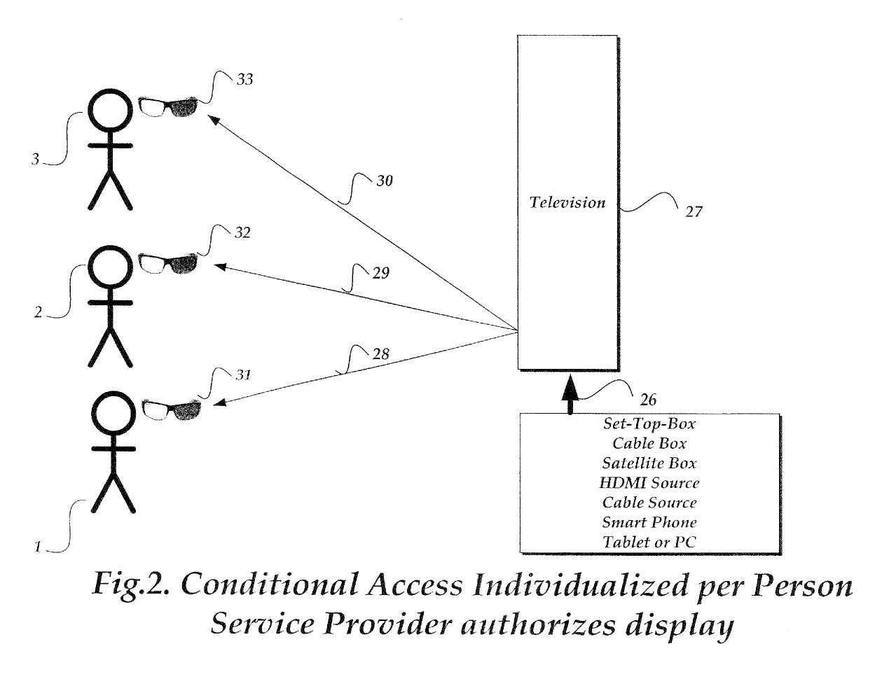

Embodiments can also allow for enabling the use of a specific count of shutter glasses to be used, or for a set of shutter glasses to be used with a specific display, for a specific period of time, for specific content, and/or for a specific amount of time. FIG. 2 shows a schematic for a system for providing conditional access to one or more viewers. Each pair of shutter glasses can have a unique identifier. Each pair of shutter glasses can also function as an RFID with a long unique address that can be a shortened or renamed address for use on, for example, an interface so as to be readable by a human. In an embodiment, each detected pair of shutter glasses is represented as a screen with a graphic and a short unique identifier. In another embodiment, the user can determine which glasses are authorized by trial and error. Embodiments can allow control of shutter glasses that are normally authorized to operate with a specific display, such that specific pairs of shutter glasses, or all pairs of shutter glasses, normally authorized to operate with the display are only authorized to do so during a specific period and a specific time. As an example, shutter glasses that are normally authorized to operate with a specific display can be controlled such that the shutter glasses are only authorized to operate if a specific piece of content, or a specific type of content (e.g., R-rated) is being used during a designated period of time. Further, shutter glasses that are normally authorized to operate can be controlled such that the shutter glasses are only authorized to operate if a specific piece of content, or a specific type 5 of content (e.g., G-rated) is not being used during a specific period of time or at all times.

In an embodiment, the signal carrying instructions for the number of shutter glasses, which shutter glasses, the time period, and/or the duration of time this is authorized is transmitted along with the video content to the shutter glasses. The shutter glasses can have circuitry for interpreting the signal, in a specific embodiment of the system and method.

In another embodiment, the number of shutter glasses, which shutter glasses, the time period, and/or the duration of authorization is chosen by one or more of the end users. One or more of the end users can select the number of shutter glasses, which shutter glasses, the time period, and/or the duration of authorization as a result of payment choices presented by the service provider and chosen by the one or more of the end users.

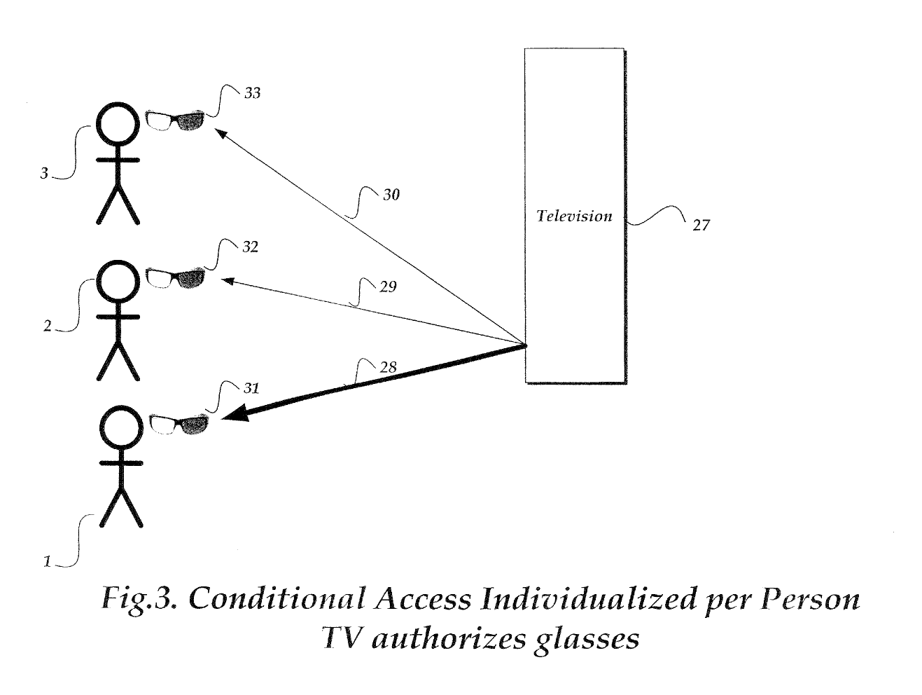

Embodiments pertain to a system and method for enabling a specific count of shutter glasses, or a set of shutter glasses, for use with a specific display, for one or more specific periods of time, in which the number of shutter glasses and duration of operation is controlled by the television or display. FIG. 3 shows a schematic of a system that utilizes a TV to provide conditional access to content to one or more viewers. The number of shutter glasses and duration of operation authorized can be transmitted separately or along with the video content to the shutter glasses. The number of shutter glasses and duration of operation can be chosen by one or more end users as a result of payment choices presented by the service provider and chosen by the one or more end users.

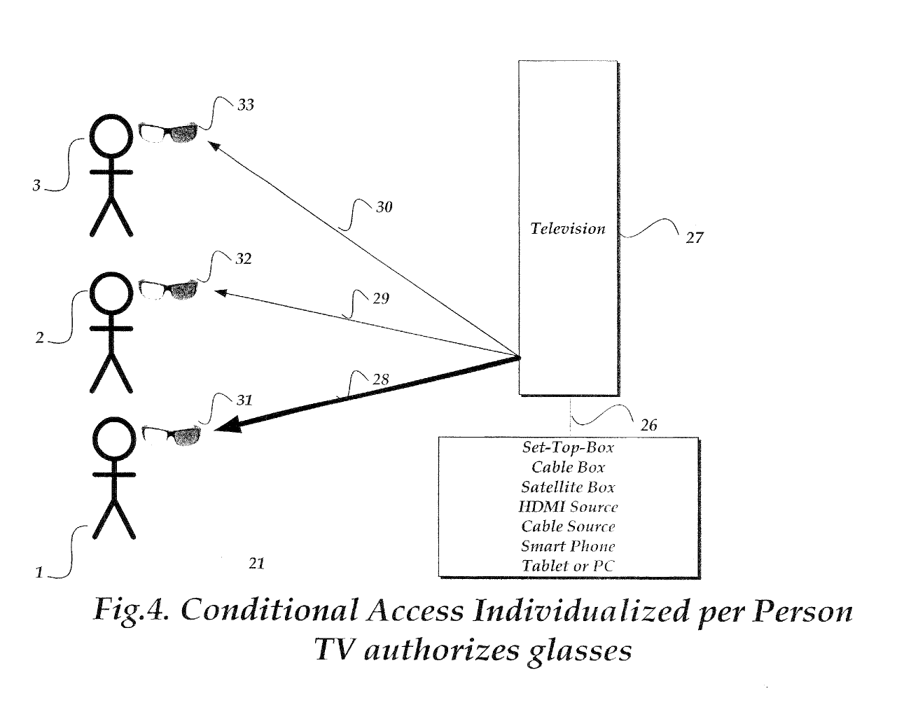

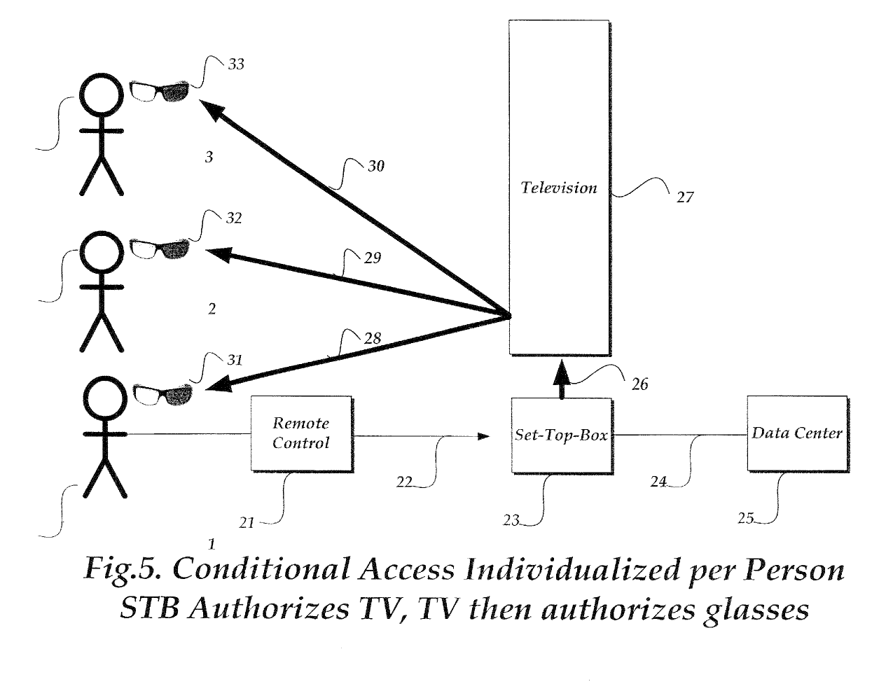

Embodiments pertain to a system and method for enabling a specific count of shutter glasses, or a set of shutter glasses, for use with a specific display, for one or more specific periods of time, in which the number of shutter glasses and duration of operation is controlled by the set-top-box. The control signal can be communicated to the shutter glasses from the set-topbox directly to the shutter glasses, or from the set-top-box via the television. FIGS. 4 and 5 show schematics of two systems that utilize a set-top-box to communicate with a TV to control the TV providing conditional access to content to one or more viewers. The number of shutter glasses and duration of operation authorized can be transmitted separately or along with the television content. The number of shutter glasses and duration of operation can be chosen by one or more end users as a result of payment choices presented by the service provider and chosen by the one or more end users.

In an embodiment, the television can act as a repeater to enable an authorization session between the set-top-box and each individual pair of shutter glasses. After the authorization of each individual pair of shutter glasses, the television can transmit the synchronization and operational information to each individual pair of glasses. In order to allow the shutter glasses to be operational, the television can provide each authorized unit of glasses with an encryption key. After the distribution of an encryption key to one or more shutter glasses or a set of shutter glasses, the television can then broadcast the synchronization and operational information using the encryption key and/or using a signal encrypted in accordance with the encryption key.

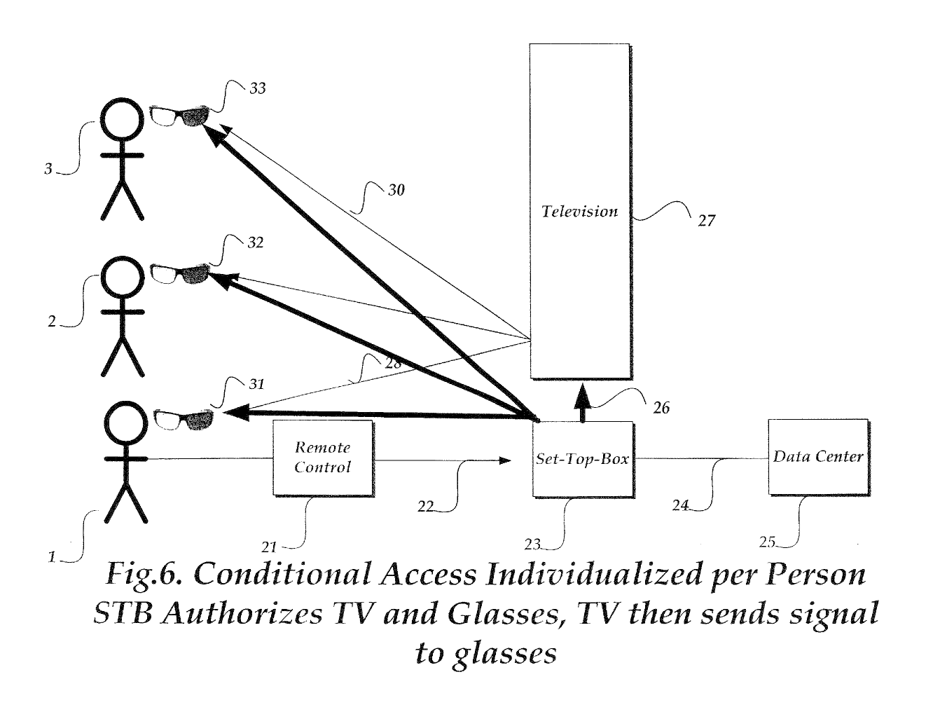

Embodiments of the invention also pertain to a system and method for enabling a specific count of shutter glasses, or set of shutter glasses, for use with a specific display for one or more specific periods of time, in which the number of shutter glasses and duration of operation is controlled by the set-top-box and communicated to the shutter glasses via the set-top-box. FIG. 6 shows a schematic of a system that utilizes a set-top-box to communicate with shutter glasses to provide conditional access to content to one or more viewers. The set-top-box can transmit authorization information to both the television and one or more shutter glasses, or a set of shutter glasses. The authorization information can be an encryption key or other signal that allows the shutter glasses to view the content. The number of shutter glasses and duration of operation authorized can be is transmitted along with the television content to the set-top-box. The number of shutter glasses and duration of operation can be chosen by one or more end users as a result of payment choices presented by the service provider and chosen by the one or more end users.

The set-top-box can authorize each individual unit of shutter glasses, and then transmit authorization information to the television. The authorization information can include an encryption key. In an embodiment, each individual pair of shutter glasses can receive authorization information from the set-top-box, either specifically for the individual pair of shutter glasses or general authorization information that authorizes more than one pair of shutter glasses, and receive its synchronization and operational information from the television. In an embodiment, the authorization information sent from the set-top-box to the shutter glasses can include an encryption key that is used by the television for the encryption of the information from the television to the glasses. In another embodiment, the authorization information sent from the set-top-box to the glasses includes an encryption key that is used by the television for the encryption of information that is broadcast from the television. In a further embodiment, encryption keys are used to seed or initiate the generation and exchange of additional encryption keys.

With respect to certain embodiments where the television or display controls the enabling of the shutter glasses to operate, the signal from the television to the shutter glasses is chosen from the following: infra-red light, visible light, radio frequency communications, the IEEE 802.15.1 radio, the IEEE 802.15.4 radio, the IEEE 802.11 radio, Bluetooth, ZigBee, Wi-Fi, or ZWave. With respect to certain embodiments where the set-top-box controls the enabling of the shutter glasses to operate, the signal from the television to the shutter glasses is chosen from the 15 following: infra-red light, visible light, radio frequency communications, the IEEE 802.15.1 radio, the IEEE 802.15.4 radio, the IEEE 802.11 radio, Bluetooth, ZigBee, Wi-Fi, or Z-Wave. In various embodiments, the signal to the television or display is chosen from the following: cable television, ATSC, DVB, HDMI, DisplayPort, the IEEE 802.11 radio, Wi-Fi, 4G cellular, UltraWideband Radio, Thunderbolt, USB, or Firewire.

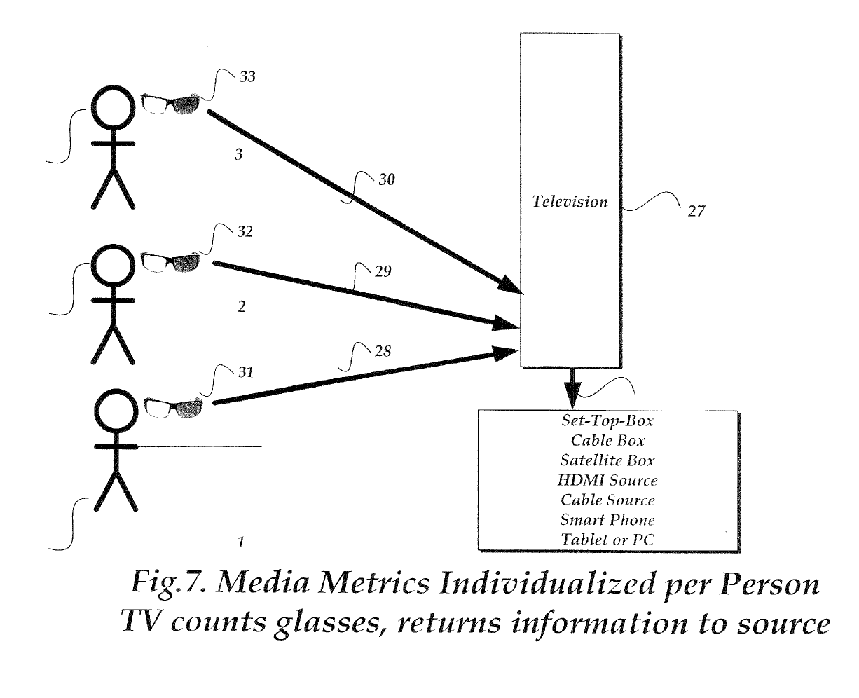

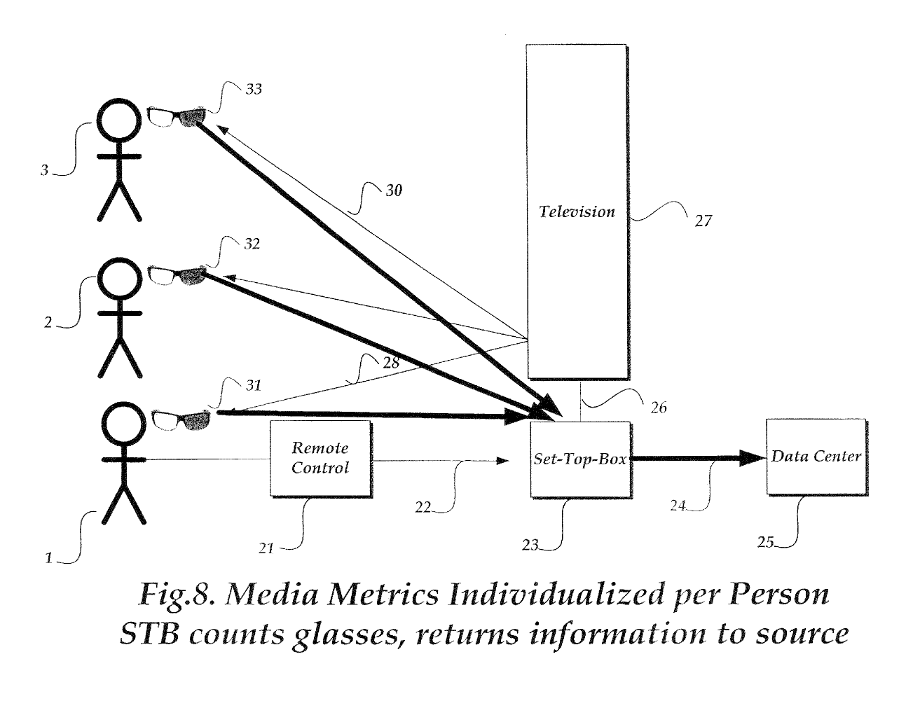

Embodiments also relate to a method and apparatus for collecting individualized media metrics with respect to one or more viewers. FIG. 7 shows a schematic of a system that utilizes the shutter glasses to collect media metrics from one or more viewers, where a signal from the shutter glasses goes to a TV. The media metrics can be collected by a display device, a set-top-box, a video source, or other mechanism. FIG. 8 shows a schematic of a system that utilizes the shutter glasses to collect media metrics from one or more viewers, where a signal from the shutter glasses goes to a set-top-box. The media metrics can be collected at one or more times and/or over one or more time periods, such as at the transition, to or midpoint of, a particular segment of content or advertisement, after a certain number of seconds or minutes, after an interaction with a human interface device, and/or at times indicated by a messages within the content.

A variety of media metrics can be determined in accordance with specific embodiments of the invention. The media metric can be one or more of the following: the maximum number of viewers for which a piece of on-demand or pay-per-view content has been authorized; a set of statistics related to the maximum, minimum, average or mean number of viewers for a unit of content; the actual number of 3D shutter glasses authorized for a unit of content; the number of shutter glasses in use for a unit of content, moment in time, or over a period of time. When determining the number of shutter glasses in use for a unit of content, moment in time, or over a period of time, whether a pair of shutter glasses is in use can be determined by the activation of a tilt sensor incorporated into a pair of 3D shutter glasses. The media metric can also include one or more of the following: both the number of shutter glasses in use, an approximation of which glasses are in the area where the content is being viewed, and/or the approximate distance of each pair of glasses from the display based on the strength of the synchronization signal from the display as received from the glasses; whether the shutter glasses are being worn on a face based on the feedback from a proximity sensor incorporated into the glasses; whether the wearer of the shutter glasses is in the area of the display or looking toward the display based on data about the position of the glasses in three dimensional space. When the position of the shutter glasses in three dimensional space is determined, such three-dimensional position can be determined via a variety of ways, such as by two way communications between the shutter glasses and a multiple-input multiple-output (MIMO) radio, or by the shutter glasses reception of visible or infra-red light from the display, an emitter, or a plurality of emitters.

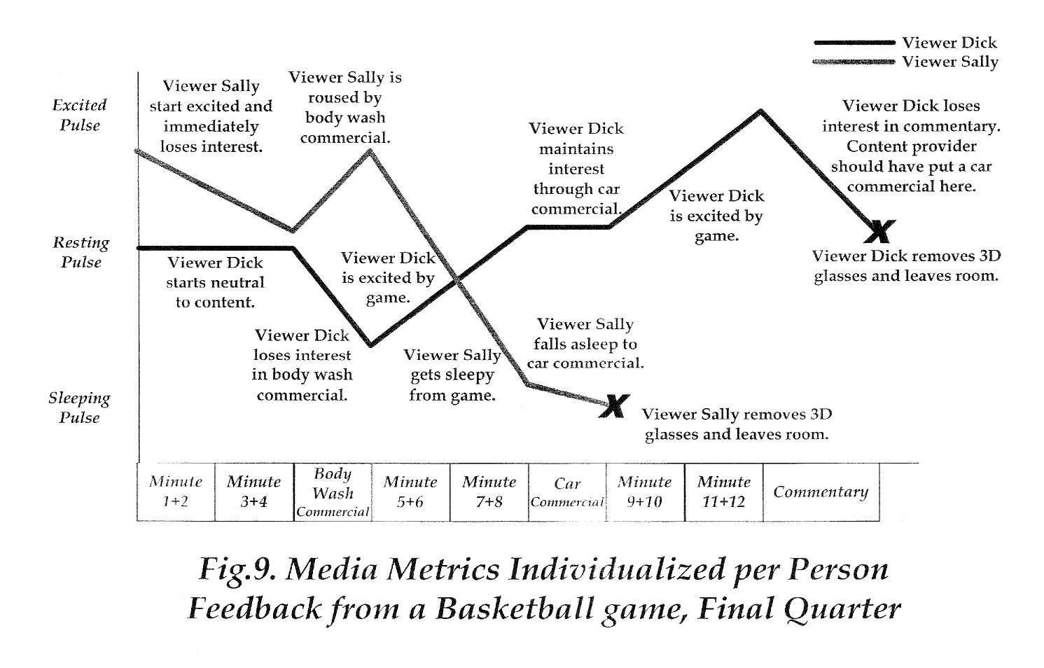

The media metric can also include the breathing or pulse rate of an individual wearing the shutter glasses or proximate to the shutter glasses. In an embodiment, the breathing or pulse rate of the individual is determined by position sensors, acceleration sensors, or pressure sensors incorporated into the glasses. FIG. 9 shows an example graph of individualized media metrics collected in accordance with an embodiment of the invention.

The media metrics can be returned to a cable operator, one or more advertisers, the TV manufacturer, an operator of a business providing the shutter glasses and/or viewing system or other appropriate party. The media metrics can be returned using a cable modem, Tru2way, OpenCable protocol, or other method. In an embodiment, the media metrics are returned via interaction with a cable set-top-box. The media metrics can be returned to a satellite television operator using, for example, a two-way satellite network, dial-up phone line, the Internet, or a private network. The media metrics can be returned to an Internet Protocol Television operator using, for example, the Internet Protocol or a Broadband Forum protocol. The media metrics can be returned to a third party data collection agency, or other third party, using, for example, the 5 Internet Protocol, a cellular network, or a private network.

The media metrics can include determining the number of individuals watching a display. Such a count can be used to provide metrics about one or more specific pieces of content, to provide metrics on advertising watching by viewers, or to provide other valuable information. The number of individual viewers watching the display can be determined in a variety of manners, including, but not limited to, the following: the use of a camera and software that performs face recognition; the use of a camera incorporated into the display; the use of a camera incorporated into a PC, table computer, or smart phone, which also incorporates the display; the use of a camera incorporated a set-top-box, computer, table computer, or smart phone, which provides a video signal to an external display; the use of a 3D camera incorporated into the display; the use of a 3D camera incorporated into a PC, table computer, or smart phone, which also incorporates the display; the use of a 3D camera incorporated into a set-top-box, computer, table computer, or smart phone, which provides a video signal to an external display; the use of a camera that also estimates the position of each viewer in the room; the use of a 3D camera that also estimates the position of each viewer in the room; the use of a camera that also uses image processing technology to estimate the age, height, weight, gender, ethnicity, wakefulness, motion, breathing rate, pulse, and/or other biological attribute of each individual in the room; the use of a 3D camera which also uses image processing technology to estimate the age, height, weight, gender, ethnicity, wakefulness, motion, breathing rate, pulse, or other biological attribute of each individual in the room.

In further embodiments, the number of individual viewers watching the display can be estimated by using a cellular network to determine the number of cellular phones and tablets within a proximal distance to a display; or estimated by using LAN and PAN technology to determine the number of cellular phones and tablets within a proximal distance to a display. The PAN technology can be Bluetooth or Bluetooth Low Energy. The LAN technology can he WiFi or IEEE 802.11. In further embodiments, the number of individual viewers watching the display can be estimated by using location-based data about the geographic location of the content subscriber and the viewers obtained from one or more of, or a combination of, the following: billing records for installations, location-reporting software that the end-user has downloaded and installed, and location data available from service providers. In an embodiment, the number 5 of individual viewers, and other individualized information and biological data, can be determined via one or more of the following: a camera, a 3D camera, the presence of, and/or feedback from, 3D glasses, the presence of a cellular device, LAN and PAN technology, Bluetooth, and subscriber address location.

Embodiments of the subject invention also relate to a method and apparatus for operating 3D shutter glasses such that different viewers get different content, such as different rated versions of a show or movie, different subtitles, or different advertising content. The content provided to each viewer can be based on the biological statistics collected about each viewer.

Embodiments are also directed to a method and apparatus for authenticating an individual viewer's 3D shutter glasses to provide conditional access for a given piece of content, and elements of that content are different for different viewers based on feedback about each viewer. The feedback about each viewer that can be used includes, but is not limited to, one or more of the following: viewer age, viewer language, viewer gender, or other viewer characteristics. The viewer's age can be determined by, for example, one authorizing agent in each household, or determined by their cellular subscriber information. The feedback about each viewer can be determined by preferences entered into a remote control or other human interface device, or collected by a sensor incorporated into 3D glasses, a sensor incorporated into glasses, a camera, or a 3D camera.

### SPECIFIC EMBODIMENTS

### Embodiment 1

A system of collecting data from one or more viewers, comprising:

at least one viewing device adapted to be worn by a corresponding at least one viewer, such that each viewer of the at least one view can view provided video content via the corresponding viewing device;

a video content provider, wherein the video content provider is capable of providing the provided video content to the one or more of the at least one viewing device; and

a receiver, wherein the receiver receives data that can be used to provide one or more media metric.

### Embodiment 2

The system according to Embodiment 1, wherein the video content provider comprises at least one display, wherein the one or more of the at least one display comprises the receiver.

### Embodiment 3

The system according to Embodiment 1, wherein the video content provider comprises a set-top-box, wherein the at least one display is a television, wherein the set-top-box provides a video signal to the television, wherein the set-top-box comprises the receiver.

### Embodiment 4

The system according to Embodiment 1, wherein the receiver can receive data at multiple points in time.

### Embodiment 5

The system according to Embodiment 4, wherein the receiver is adapted to receive data at a desired point of an advertisement in the provided video content.

### Embodiment 6

The system according to Embodiment 4, further comprising an interface, wherein the interface allows a user to provide input to the system, wherein the receiver receives data after a user inputs a specific input to the interface.

### Embodiment 7

The system according to Embodiment 1, further comprising a controller, wherein the controller is capable of sending a signal to one or more of the at least one viewing device, wherein upon receipt of the signal by the one or more of the at least one viewing device, the one or more of the at least one viewing device is authorized to allow a corresponding one or more of the at least one viewer to view the provided video content via the one or more of the at least one viewing device.

### Embodiment 8

The system according to Embodiment 6, wherein the data is used to provide a first media metric, wherein the first media metric is a maximum number of the at least one viewing device that has been authorized.

### Embodiment 9

The system according to Embodiment 6, wherein the data is used to provide a first media metric, wherein the first media metric is a set of statistics related to the maximum, minimum, average, or mean number of the at least one viewing device that has been authorized.

### Embodiment 10

The system according to Embodiment 6, wherein the at least one viewing device is at least one pair of shutter glasses.

### Embodiment 11

The system according to Embodiment 10, wherein the data is used to provide a first media metric, wherein the first media metric is a number of the at least one pair of shutter glasses that has been authorized.

### Embodiment 12

The system according to Embodiment 10, where the first media metric is a number of the at least one pair of shutter glasses in use for a specific unit of the provided video content.

### Embodiment 13

The system according to Embodiment 12, wherein whether a pair of shutter glasses of the at least one pair of shutter glasses is in use is determined by a time period incurred since activation of a tilt sensor incorporated into the pair of shutter glasses.

### Embodiment 14

The system according to Embodiment 10, wherein the one or more media metric comprises both a number of pairs of shutter glasses of the at least one pair of shutter glasses in use and an approximation of which pairs of shutter glasses of the at least one pair of shutter glasses are in an area where the provided video content is being viewed.

### Embodiment 15

The system according to Embodiment 10, wherein the at least one viewing device comprises a display, wherein the one or more media metric comprises an approximate distance of each pair of shutter glasses of the at least one pair of shutter glasses from the display based on a strength of a synchronization signal from the display as received from each pair of shutter glasses.

### Embodiment 16

The system according to Embodiment 10, wherein the one or more media metric comprises whether the one or more of the at least one pair of shutter glasses are being worn on a face of the corresponding one or more of the at least one viewer based on feedback from a corresponding one or more of an at least one proximity sensor incorporated into the corresponding pair of shutter glasses.

### Embodiment 17

The system according to Embodiment 10, wherein the at least one viewing device comprises a display, wherein the one or more media metric comprises whether a viewer of a pair of shutter glasses of the at least one pair of shutter glasses is in an area of the display or whether the pair of shutter glasses is directed toward the display, based on position data regarding a position of the pair of shutter glasses in three dimensional space.

### Embodiment 18

The system according to Embodiment 17, wherein the position of the pair of shutter glasses in three dimensional space is determined by two way communications between the pair of shutter glasses and a multiple-input multiple-output (MIMO) radio.

### Embodiment 19

The system according to Embodiment 17, wherein the position of the glasses in three dimensional space is determined by reception by the pair of shutter glasses of visible or infra-red light transmitted by the display or one or more emitters.

### Embodiment 20

The system according to claim Embodiment 1, wherein the one or more media metric comprises a breathing and/or pulse rate of a viewer of the at least one viewer.

### Embodiment 21

The system according to Embodiment 20, wherein the breathing and/or pulse rate of the viewer is determined by a position sensor, an acceleration sensor, and/or a pressure sensor incorporated into the corresponding viewing device of the at least one viewing device.

### Embodiment 22

The system according to Embodiment 1, further comprising a set-top-box, wherein the one or more media metric are provided via the set-top-box to a cable operator using a cable modem, Tru2way, or OpenCable protocol.

### Embodiment 23

The system according to Embodiment 1, wherein the one or more media metric are provided to a satellite television operator using a two-way satellite network, dial-up phone line, the Internet, or a private network.

### Embodiment 24

The system according to Embodiment 1, wherein the one or more media metric are provided to an Internet Protocol Television operator using the Internet Protocol or a Broadband Forum protocol.

### Embodiment 25

The system according to Embodiment 1, wherein the one or more media metric are provided to a third party data collection agency.

### Embodiment 26

The system according to Embodiment 1, wherein the one or more media metric are provided to a third party using the Internet Protocol, a cellular network, or a private network.

### Embodiment 27

A method of determining a count of viewers viewing a display, comprising:

providing a display, wherein the display displays provided video content; and

determining a count of viewers viewing the display, wherein determining the count of viewers viewing the display comprises the use of one or more of the group consisting of: a camera, a 3D camera, a pair of 3D glasses, a cellular device, a LAN device, a PAN device, and a Bluetooth device.

### Embodiment 28

The method of Embodiment 27, wherein the count is then used to provide metrics regarding specific pieces of provided video content.

### Embodiment 29

The method of Embodiment 27, wherein determining the count comprises acquiring one or more image via a camera and processing the one or more image via face recognition software to determine a count of faces in the one or more image.

### Embodiment 30

The method of Embodiment 27, wherein determining the count comprises acquiring one or more image via a camera incorporated into the display.

### Embodiment 31

The method of Embodiment 27, wherein determining the count comprises acquiring one or more image via a camera incorporated in a PC, a table computer, or a smart phone, wherein the PC, the table computer, or the smart phone that the camera is incorporated in also incorporates the display.

### Embodiment 32

The method of Embodiment 27, wherein determining the count comprises acquiring one or more images via a camera incorporated in a set-top-box, a computer, a table computer, or a smart phone, wherein the set-top-box, the computer, the table computer, or the smart phone that the camera is incorporated in provides a video signal to an external display.

### Embodiment 33

The method of Embodiment 27, wherein determining the count comprises acquiring data via a 3D camera incorporated into the display.

### Embodiment 34

The method of Embodiment 27, wherein determining the count comprises acquiring data via a 3D camera incorporated into a PC, a table computer, or a smart phone, wherein the PC, the table computer, or the smart phone that the 3D camera is incorporated in also incorporates the display.

### Embodiment 35

The method of Embodiment 27, wherein determining the count comprises acquiring data via a 3D camera incorporated a set-top-box, computer, table computer, or smart phone, wherein the set-top-box, the computer, the table computer, or the smart phone that the 3D camera is incorporated in provides a video signal to an external display.

### Embodiment 36

The method of Embodiment 27, wherein determining the count comprises acquiring data via a camera; and processing the data to estimate a position of each viewer in an area of the display.

### Embodiment 37

The method of Embodiment 27, wherein determining the count comprises acquiring data via a 3D camera; and processing the data to estimate a position of each viewer in an area of the display.

### Embodiment 38

The method of Embodiment 27, wherein determining the count comprises acquiring data via a camera; and processing the data to determine the count, wherein the method further comprises processing the data to estimate the age, height, weight, gender, ethnicity, wakefulness, motion, breathing rate, or pulse of one or more counted viewer.

### Embodiment 39

The method of Embodiment 27, wherein determining the count comprises acquiring data via a 3D camera; and processing the data to determine the count, wherein the method further comprises processing the data to estimate the age, height, weight, gender, ethnicity, wakefulness, motion, breathing rate, or pulse of one or more counted viewer.

### Embodiment 40

The method of Embodiment 27, wherein determining the count comprises determining a number of cellular phones via use of a cellular network and tablets within a certain distance of the display.

### Embodiment 41

The method of Embodiment 27, wherein determining the count comprises determining a number of cellular phones and tablets within a certain distance of the display via use of LAN and/or PAN technology.

### Embodiment 42

The method of Embodiment 41, wherein the PAN technology is Bluetooth or Bluetooth Low Energy.

### Embodiment 43

The method of Embodiment 41, wherein the LAN technology is WiFi or IEEE 802.11.

### Embodiment 44

The method of Embodiment 27, wherein determining the count comprises using location-based data about a geographic location of a content subscriber and viewers obtained from a combination of billing records for installations, location-reporting software that the end-user has downloaded and installed, and location data available from service providers.

### Embodiment 45

A method of presenting video content, comprising:

providing at least two viewing devices adapted to be worn by a corresponding at least two viewers, such that each viewer of the at least two viewers can view provided video content via the corresponding viewing device;

providing a video content provider, wherein the video content provider is capable of providing the provided video content to the one or more of the at least two viewing devices; and

coordinating a video content presented on the display with a corresponding two or more shuttering patterns of two or more of the at least two pairs of shutter glasses such that at least two of the corresponding two or more of the at least two viewers are presented with different provided video content.

### Embodiment 46

The method according to Embodiment 45, wherein the different provided video content is different advertising video content.

### Embodiment 47

The method of Embodiment 45, wherein the provided video content provided to each viewer is based on biological statistics collected about the viewer.

### Embodiment 48

A system for presenting video content, comprising:

at least two viewing devices adapted to be worn by a corresponding at least two viewers, such that each viewer of the at least two viewers can view provided video content via the corresponding viewing device;

a video content provider, wherein the video content provider is capable of providing the provided video content to the one or more of the at least two viewing devices, wherein one or more of the at least two viewing devices are authenticated to provide conditional access for a given piece of video content and elements of the given piece of video content are different for two or more of the at least two viewers based on feedback about each viewer of the two or more of the at least two viewers.

### Embodiment 49

The method according to Embodiment 48, wherein the feedback about each viewer is an age.

### Embodiment 50

The method according to Embodiment 48, wherein the feedback about each viewer is an age of the viewer as determined by one authorizing agent in each household.

### Embodiment 51

The method according to Embodiment 48, wherein the feedback about each viewer is an age of the viewer as determined by cellular subscriber information.

### Embodiment 52

The method according to Embodiment 48, wherein the feedback about each viewer is determined by preferences entered into an interface device.

### Embodiment 53

The method according to Embodiment 48, wherein the video content provider comprises a display, wherein the at least two viewing devices comprise at least two pairs of shutter glasses, wherein the feedback about each viewer is collected by a corresponding at least two sensors incorporated into the at least two pairs of shutter glasses.

### Embodiment 54

The method according to Embodiment 48, wherein the feedback about each viewer is collected by a sensor incorporated into glasses, a camera, or a 3D camera

Aspects of the invention may be described in the general context of computer-executable instructions, such as program modules, being executed by a computer. Generally, program modules include routines, programs, objects, components, data structures, etc., that perform particular tasks or implement particular abstract data types. Moreover, those skilled in the art will appreciate that the invention may be practiced with a variety of computer-system configurations, including multiprocessor systems, microprocessor-based or programmable-consumer electronics, minicomputers, mainframe computers, and the like. Any number of computer-systems and computer networks are acceptable for use with the present invention.

Specific hardware devices, programming languages, components, processes, protocols, and numerous details including operating environments and the like are set forth to provide a thorough understanding of the present invention. In other instances, structures, devices, and processes are shown in block-diagram form, rather than in detail, to avoid obscuring the present invention. But an ordinary-skilled artisan would understand that the present invention may be practiced without these specific details. Computer systems, servers, work stations, and other machines may be connected to one another across a communication medium including, for example, a network or networks.

As one skilled in the art will appreciate, embodiments of the present invention may be embodied as, among other things: a method, system, or computer-program product. Accordingly, the embodiments may take the form of a hardware embodiment, a software embodiment, or an embodiment combining software and hardware. In an embodiment, the present invention takes the form of a computer-program product that includes computer-useable instructions embodied on one or more computer-readable media.

Computer-readable media include both volatile and nonvolatile media, removable and nonremovable media, and contemplate media readable by a database, a switch, and various other network devices. By way of example, and not limitation, computer-readable media comprise media implemented in any method or technology for storing information. Examples of stored information include computer-useable instructions, data structures, program modules, and other data representations. Media examples include, but are not limited to, infoiniation-delivery media, RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently.

The invention may be practiced in distributed-computing environments where tasks are performed by remote-processing devices that are linked through a communications network. In a distributed-computing environment, program modules may be located in both local and remote computer-storage media including memory storage devices. The computer-useable instructions form an interface to allow a computer to react according to a source of input. The instructions cooperate with other code segments to initiate a variety of tasks in response to data received in conjunction with the source of the received data.

The present invention may be practiced in a network environment such as a communications network. Such networks are widely used to connect various types of network elements, such as routers, servers, gateways, and so forth. Further, the invention may be practiced in a multi-network environment having various, connected public and/or private networks.

Communication between network elements may be wireless or wireline (wired). As will be appreciated by those skilled in the art, communication networks may take several different forms and may use several different communication protocols. And the present invention is not limited by the forms and communication protocols described herein.

All patents, patent applications, provisional applications, and publications referred to or cited herein are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

What is claimed is:

1. A system for providing video content to at least one viewer, comprising:
at least one viewing device adapted to be worn by a corresponding at least one viewer, such that each viewer of the at least one viewer can view provided video content via the corresponding viewing device once the corresponding viewing device is authorized;
a controller, wherein the controller is capable of sending a signal to one or more of the at least one viewing device, wherein upon receipt of the signal by the one or more of the at least one viewing device, the one or more of the at least one viewing device is authorized to allow a corresponding one or more of the at least one viewer to view the provided video content via the one or more of the at least one viewing device; and
a video content provider, wherein the video content provider is capable of providing the provided video content to the one or more of the at least one viewing device.

2. The system according to claim 1, wherein the one or more of the at least one viewing device is a specific number of the at least one viewing device.

3. The system according to claim 2, further comprising an interface, wherein the specific number is provided by an operator via the interface.

4. The system according to claim 3, wherein the specific number is a number of authorized viewings of the provided video content purchased.

5. The system according to claim 4, wherein the specific number can be incrementally increased after the initial time of purchase.

6. The system according to claim 1, wherein the specific number is automatically incrementally increased after the initial purchase if an additional one or more viewers attempts to use one or more of the at least one viewing device that is not activated.

7. The system according to claim 1, wherein a cost of the provided content is determined by the specific number.

8. The system according to claim 6, wherein a cost of the provided content is adjusted automatically as additional one or more viewers view the provided content.

9. The system according to claim 1, wherein the video content provider comprises one or more displays, wherein the at least one viewing device is at least one pair of shutter glasses.

10. The system according to claim 2, wherein upon receipt of the signal by the one or more of the at least one viewing device, the one or more of the at least one viewing device is authorized to allow the corresponding one or more of the at least one viewer to view the provided video content for a specified amount of time.

11. The system according to claim 9, wherein the one or more displays is a specific display, wherein the at least one pair of shutter glasses is authorized to operate with the specific display.

12. The system according to claim 11, wherein the at least one pair of shutter glasses is authorized to operate with the specific display only during a specific period of time.

13. The system according to claim 12, wherein the at least one pair of shutter glasses is authorized to operate only when a specific piece of video content is provided during the specific period of time.

14. The system according to claim 12, wherein the at least one pair of shutter glasses is authorized to operate only when a specific piece of video content is not provided during that the specific period of time.

15. The system of claim 10, wherein the specific number and specific amount of time is transmitted to the one or more of the at least one viewing device along with the provided video content.

16. The system of claim 10, wherein the specific number and specific amount of time is chosen by one of the at least one viewer.

17. The system according to claim 16, wherein the specific number and specific amount of time is chosen as a result of payment choices presented by the service provider and chosen by the one of the at least one viewer.

18. The system according to claim 10, wherein the video content provider comprises a display, wherein the at least one viewing device is at least one pair of shutter glasses, wherein a control signal controlling the specific number and specific amount of time is sent by the display to the one or more of the at least one viewing device.

19. The system according to claim 18, wherein the control signal is transmitted along with the provided video content.

20. The system according to claim 18, wherein the display is a television.

21. The system according to claim 10, wherein the video content provider comprises a display, wherein the at least one viewing device is at least one pair of shutter glasses, wherein a control signal controlling the specific number and specific amount of time is sent by a set-top-box to the display and sent by the display to the one or more of the at least one viewing device.

22. The system according to claim 21, wherein the control signal is transmitted along with the provided video content.

23. The system according to claim 21, wherein the display is a television.

24. The system according to claim 23, wherein after the controller sends the signal to the one or more of the at least one pair of shutter glasses such that the one or more of the at least one pair of shutter glasses is authorized to allow a corresponding one or more of the at least one viewer to view the provided video content via the one or more of the at least one pair of shutter glasses, the television transmits the synchronization and operational information to the one or more of the at least one pair of shutter glasses.

25. The system according to claim 23, wherein the television provides each of the one or more of the at least one pair of shutter glasses with an encryption key.

26. The system according to claim 23, wherein after the television provides each of the one or more of the at least one pair of shutter glasses with the encryption key the television broadcasts synchronization and operational information using the encryption key.

27. The system according to claim 10, wherein the video content provider comprises a display, wherein the at least one viewing device is at least one pair of shutter glasses, wherein a control signal controlling the specific number and specific amount of time is sent by a set-top-box to the one or more of the at least one viewing device.

28. The system according to claim 27, wherein the display is a television, wherein the set-top-box sends authorization information to both the television and the one or more of the at least one viewing device.

29. The system according to claim 27, wherein the authorization information is an encryption key.

30. The system according to claim 27, wherein the specific number and specific amount of time is sent along with the provided video content to the set-top-box.

31. The system according to claim 27, wherein the controller is located in a set-top-box, wherein the set-top-box sends authorization information to the television.

32. The system according to claim 31, wherein the authorization information includes an encryption key.

33. The system according to claim 27, wherein the display is a television, wherein the controller is located in a set-top-box, wherein the set-top-box sends authorization information to the one or more of the at least one viewing device, wherein the television sends synchronization and operational information to the one or more of the at least one viewing device.

34. The system according to claim 33, wherein the authorization information sent from the set-top-box to the one or more of the at least one viewing device includes an encryption key, wherein the encryption key is used by the television for the encryption of the operational information from the television to the one or more of the at least one viewing device.

35. The system according to claim 33, wherein the authorization information sent from the set-top-box to the one or more of the at least one viewing device includes an encryption key, wherein the encryption key is used by the television for the encryption of video content which is broadcast from the television.

36. The system according to claim 34, wherein the encryption key is used to seed or initiate generation and exchange of additional encryption keys.

37. The system according to claim 18, wherein the display is a television, wherein the controller is located in the television, wherein the at least one viewing device is at least one pair of shutter glasses, wherein the signal from the television to the at least one pair of shutter glasses is selected from the group consisting of: infra-red light, visible light, radio frequency communications, the IEEE 802.15.1 radio, the IEEE 802.15.4 radio, the IEEE 802.11 radio, Bluetooth, ZigBee, Wi-Fi, or Z-Wave.

38. The system according to claim 21, wherein the display is a television, wherein the controller is located in the television, wherein the at least one viewing device is at least one pair of shutter glasses, wherein the signal from the television to the at least one pair of shutter glasses is selected from the group consisting of: infra-red light, visible light, radio frequency communications, the IEEE 802.15.1 radio, the IEEE 802.15.4 radio, the IEEE 802.11 radio, Bluetooth, ZigBee, Wi-Fi, or Z-Wave.

39. The system according to claim 27, wherein the display is a television, wherein the controller is located in the television, wherein the at least one viewing device is at least one pair of shutter glasses, wherein the signal from the television to the at least one pair of shutter glasses is selected from the group consisting of: infra-red light, visible light, radio frequency communications, the IEEE 802.15.1 radio, the IEEE 802.15.4 radio, the IEEE 802.11 radio, Bluetooth, ZigBee, Wi-Fi, or Z-Wave.

40. The system according to claim 18, wherein a control signal is sent to the display by a set-top-box, wherein a format for the control signal is selected from the group consisting of: cable television, ATSC, DVB, HDMI, DisplayPort, the IEEE 802.11 radio, Wi-Fi, 4G cellular, Ultra-Wideband Radio, Thunderbolt, USB, and Firewire.

41. The system according to claim 21, wherein a format of the control signal to the display is selected from the group consisting of: cable television, ATSC, DVB, HDMI, DisplayPort, the IEEE 802.11 radio, Wi-Fi, 4G cellular, Ultra-Wideband Radio, Thunderbolt, USB, or Firewire.

42. The system according to claim 27, wherein a format of the control signal to the display is selected from the group consisting of: cable television, ATSC, DVB, HDMI, DisplayPort, the IEEE 802.11 radio, Wi-Fi, 4G cellular, Ultra-Wideband Radio, Thunderbolt, USB, or Firewire.

43. A system of collecting data from one or more viewers, comprising:
at least one viewing device adapted to be worn by a corresponding at least one viewer, such that each viewer of the at least one view can view provided video content via the corresponding viewing device;
a video content provider, wherein the video content provider is capable of providing the provided video content to the one or more of the at least one viewing device; and
a receiver, wherein the receiver receives data that can be used to provide one or more media metric.

44. A method of determining a count of viewers viewing a display, comprising:
providing a display, wherein the display displays provided video content; and
determining a count of viewers viewing the display, wherein determining the count of viewers viewing the display comprises the use of one or more of the group consisting of: a camera, a 3D camera, a pair of 3D glasses, a cellular device, a LAN device, a PAN device, and a Bluetooth device.

45. A method of presenting video content, comprising:
providing at least two viewing devices adapted to be worn by a corresponding at least two viewers, such that each viewer of the at least two viewers can view provided video content via the corresponding viewing device;
providing a video content provider, wherein the video content provider is capable of providing the provided video content to the one or more of the at least two viewing devices; and
coordinating a video content presented on the display with a corresponding two or more shuttering patterns of two or more of the at least two pairs of shutter glasses such that at least two of the corresponding two or more of the at least two viewers are presented with different provided video content.

46. A system for presenting video content, comprising:
at least two viewing devices adapted to be worn by a corresponding at least two viewers, such that each viewer of the at least two viewers can view provided video content via the corresponding viewing device;
a video content provider, wherein the video content provider is capable of providing the provided video content to the one or more of the at least two viewing devices, wherein one or more of the at least two viewing devices are authenticated to provide conditional access for a given piece of video content and elements of the given piece of video content are different for two or more of the at least two viewers based on feedback about each viewer of the two or more of the at least two viewers.
